(19) United States
(12) Patent Application Publication
(10) Pub. No.: US 2007/0280667 A1
(43) Pub. Date: Dec. 6, 2007

(54) CAMERA LENS MODULE HAVING AUTO-FOCUSING DEVICE

(76) Inventor: Doo-Sik SHIN, Suwon-si (KR)

Correspondence Address: CHA & REITER, LLC, 210 ROUTE 4 EAST STE 103, PARAMUS, NJ, 07652, US

(21) Appl. No.: 11/672,582

(22) Filed: Feb. 8, 2007

(30) Foreign Application Priority Data
Jun. 1, 2006 (KR) 2006-49384

(51) Int. Cl. G03B 3/10

(52) U.S. Cl. 396/133

(57) ABSTRACT

A camera lens module comprises an image sensor, a lens assembly arranged on an optical axis of the image sensor, a rotator rotatably mounted to surround one part of the lens assembly, a piezoelectric motor mounted to surround the other part of the lens assembly, for providing a driving force for rotating the rotator and a threaded section formed on the lens assembly and the rotator, wherein the threaded section converts rotation of the rotator into linear movement of the lens assembly along the optical axis of the image sensor to adjust a focal distance of the lens assembly. Since the piezoelectric motor is employed as a driving source for auto-focusing, miniaturization can be advantageously attained, whereby the camera lens module having an auto-focusing device can be easily mounted to a digital camera as well as a mobile communication terminal.

### CLAIM OF PRIORITY

This application claims the benefit of the earlier filing date, pursuant to 35 USC 119, to that patent application entitled “Camera Lens Module having Auto-Focusing Device,” filed in the Korean Intellectual Property Office on Jun. 1, 2006 and assigned Serial No. 2006-49384, the contents of which are hereby incorporated by reference.

### BACKGROUND OF THE INVENTION

1. Field of the Invention

The present invention relates to a camera lens module, and more particularly to a camera lens module which is constructed to automatically adjust the focal distance of a lens in an optical unit mounted to a digital camera or a mobile communication terminal.

2. Description of the Related Art

With the development of techniques for miniaturization and light weight of digital cameras, it has become possible to mount a camera to a mobile communication terminal, e.g. cellular telephones personal digital assistant, and mobile communication terminals mounted with an optical lens and a camera device have been widely distributed throughout the world.

At an early stage in which a camera was initially mounted to a mobile communication terminal, the performance of the camera mounted to a mobile communication terminal was significantly inferior to that of the digital camera commercialized at that time. For example, while the performance of a popular edition digital camera was 4 million pixels or so, the performance of the camera mounted to a mobile communication terminal was about 3 hundred thousand pixels, and, even in the case of a high grade mobile communication terminal, the performance of a camera was no greater than 1 million pixels.

Recently, it is the norm that a camera having a resolution of 1 million pixels or so is incorporated into a mobile communication terminal. In the case of a high grade terminal, a camera having a resolution of around 3 million pixels, which corresponds to that of a popular edition digital camera is incorporated into to a mobile communication terminal. And a mobile communication terminal mounted with a camera having the performance of 7 million pixels has been successfully commercialized.

The improvement in the functionality of a camera incorporated into to a mobile communication terminal was possible because of improvements in the precision of a technique for manufacturing a camera lens module. However, even though the performance of a camera lens module and the precision of a manufacturing technique thereof have improved and thereby mobile communication terminals gradually make inroads on digital camera markets, when considering the main functions of a mobile communication terminal, i.e., the maintenance of communication and portability, limitations exist in making the performance of the camera mounted to a mobile communication terminal reach the same level as that of a digital camera.

In this regard, even a normal compact type digital camera is basically provided with an optical zoom function and an auto-focusing function, and some digital cameras have a shake compensation function. However, in a mobile communication terminal, since the communication maintaining function and portability must be considered, difficulties are caused in providing an optical zoom function, an auto-focusing function and a shake compensation function to the camera incorporated into to a mobile communication terminal.

### SUMMARY OF THE INVENTION

Accordingly, the present invention has been made to solve the above-mentioned problems occurring in the prior art and provides additional advantages, by providing a camera lens module having an auto-focusing function and is advantageous to miniaturization.

According to one aspect of the present invention, there is provided a camera lens module comprising an image sensor, a lens assembly arranged on an optical axis of the image sensor, a rotator rotatably mounted to surround one part of the lens assembly, a piezoelectric motor mounted to surround another part of the lens assembly, for providing driving force for rotating the rotator, and a threaded section formed on the lens assembly and the rotator, wherein the threaded section converts rotation of the rotator into linear movement of the lens assembly along the optical axis of the image sensor to adjust a focal distance of the lens assembly.

According to another aspect of the present invention, there is provided a camera lens module comprising an image sensor, a lens assembly arranged on an optical axis of the image sensor to be linearly moved, a rotator rotatably mounted to surround one part of the lens assembly, a piezoelectric motor mounted to surround another part of the lens assembly, for providing driving force for rotating the rotator, a permanent magnet installed adjacent to the piezoelectric motor to apply attractive force for bringing the rotator into close contact with the piezoelectric motor, a threaded section formed on the lens assembly and the rotator and a guide section provided between the lens assembly and the piezoelectric motor to guide linear movement of the lens assembly, wherein the threaded section converts rotation of the rotator into linear movement of the lens assembly along the optical axis of the image sensor to adjust a focal distance of the lens assembly.

### BRIEF DESCRIPTION OF THE DRAWINGS

The above features and advantages of the present invention will be more apparent from the following detailed description taken in conjunction with the accompanying drawings, in which:

FIG. 1 is a perspective view illustrating a camera lens module having an auto-focusing device in accordance with an embodiment of the present invention;

FIG. 2 is a longitudinally cross-sectioned perspective view illustrating the camera lens module shown in FIG. 1;

FIG. 3 is a diagonally cross-sectioned view illustrating the camera lens module shown in FIG. 1;

FIG. 4 is an exploded perspective view illustrating the main component parts of the camera lens module shown in FIG. 1;

FIG. 5 is an exploded perspective view illustrating a lens assembly and a piezoelectric motor of the camera lens module shown in FIG. 1; and

FIG. 6 is an exploded perspective view illustrating a rotator and the piezoelectric motor of the camera lens module shown in FIG. 1.

### DETAILED DESCRIPTION

Hereinafter, embodiments of the present invention will be described with reference to the accompanying drawings. In the following description, the same elements will be designated by the same reference numerals although they are shown in different drawings. For the purposes of clarity and simplicity, a detailed description of known functions and configurations incorporated herein will be omitted as it may make the subject matter of the present invention rather unclear.

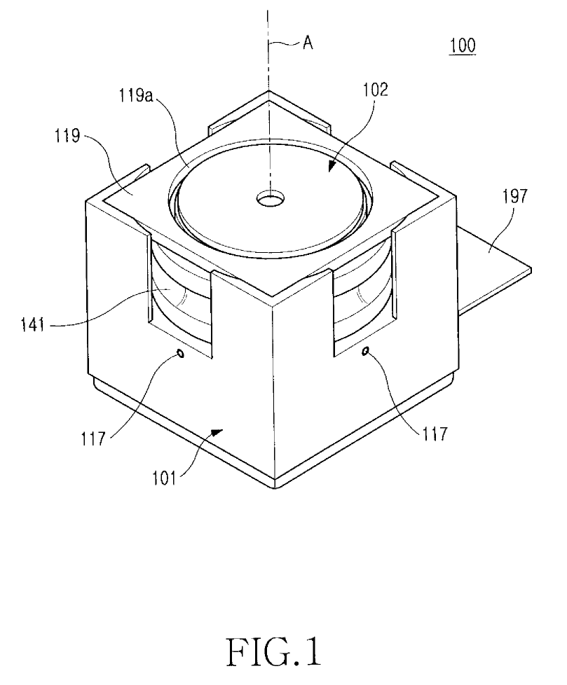

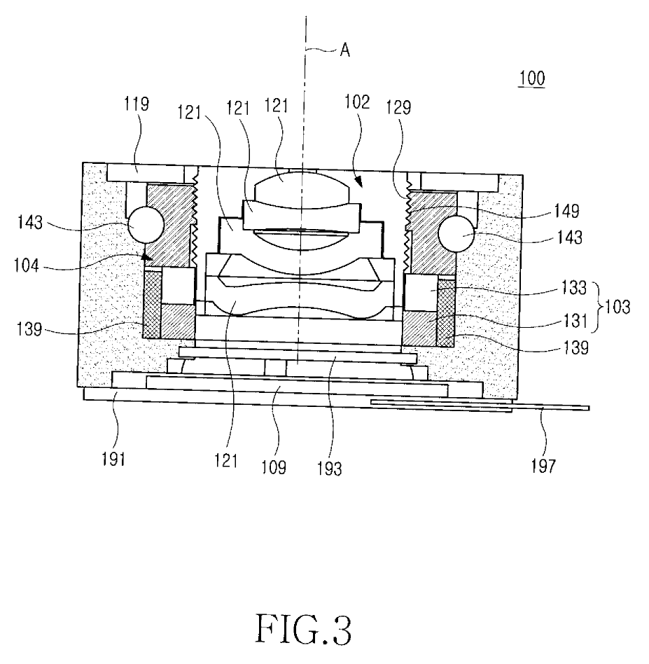

Referring to FIGS. 1 through 3, a camera lens module 100 having an auto-focusing device in accordance with an embodiment of the present invention includes a rotator 104 (FIG. 3) and a piezoelectric motor 103 (FIG. 3), which are mounted to surround a lens assembly 102, and an image sensor 109. As the lens assembly 102, the rotator 104, and the piezoelectric motor 103 are contained in a module housing 101 (FIG. 1), the camera lens module 100 has a modular configuration.

The module housing 101 has a hollow square column-shaped configuration which is opened at one end. The respective sides of the module housing 101 are partially cut away, and portions of an edge of the rotator 104 are received through the cut-away portions of the module housing 101. The other end of the module housing 101 is partially opened, and the image sensor 109 is mounted in the module housing 101 through the partially opened portion of the other end of the module housing 101. The imaging surface of the image sensor 109 is positioned in the module housing 101 and faces the opened end of the module housing 101.

The lens assembly 102 comprises a plurality of lenses 121 disposed therein, and is arranged on the optical axis ‘A’ of the image sensor 109. The lens assembly 102 can be linearly moved in the module housing 101 along the direction of the optical axis ‘A’ of the image sensor 109, whereby the focal distance of the lenses 121 can be adjusted.

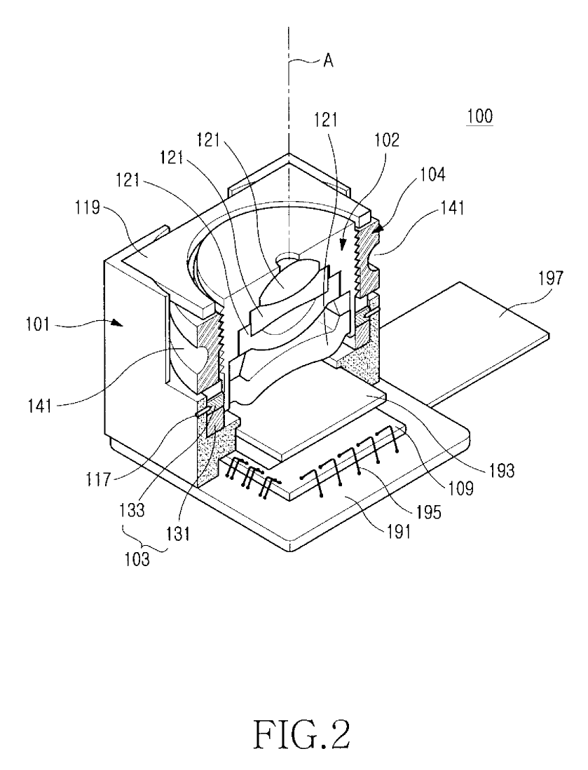

The rotator 104 is mounted to surround one part of the circumferential outer surface of the lens assembly 102 and can be rotated in the module housing 101. In order to facilitate the rotation of the rotator 104, ball bearings 143 are located between the inner surface of the module housing 101 and the circumferential outer surface of the rotator 104 at regular angles in the circumferential direction. The balls 143 function to constantly maintain a gap between the inner surface of the module housing 101 and the circumferential outer surface of the rotator 104 so as to prevent the module housing 101 and the rotator 104 from being brought into direct frictional contact with each other and facilitate the rotation of the rotator 104. In order to prevent the release of the balls 143 from the circumferential outer surface of the rotator 104, a rotation guide groove 141 is defined on the circumferential outer surface of the rotator 104 to extend in the circumferential direction, and the ball bearings 143 are partially received in the rotation guide groove 141 (FIG. 2). In the present embodiment, two pairs of balls 143 are used, and are respectively positioned adjacent to the corners of the module housing 101 as shown in FIG. 3.

Meanwhile, a threaded section is provided between the rotator 104 and the lens assembly 102 to convert the rotational motion of the rotator 104 into the linear movement of the lens assembly 102.

The threaded section comprises a first threaded part 129 which is formed on the circumferential outer surface of the lens assembly 102, and a second threaded part 149 which is formed on the circumferential inner surface of the rotator 104 and is coupled with the first threaded part 129 such that when the rotator 104 is rotated the second threaded part 149 is rotated, the first threaded part 129 is linearly moved. In this way, the rotation of the rotator 104 is converted into the linear movement of the lens assembly 102.

A cover 119 (FIG. 1) is placed on the opened end of the module housing 101 to prevent the rotator 104 from being linearly moved and to expose one end of the lens assembly 102. The cover 119 is defined with an exposure opening 119a and partially closes the opened end of the module housing 101. One end of the lens assembly 102 is exposed to the outside through the exposure opening 119a so that the image of a subject can be incident on the camera lens module 100, that is, the lens assembly 102.

As the linear movement of the rotator 104 is prevented by the cover 119, the rotator 104 is restrained from being linearly moved in the direction of the optical axis ‘A’ of the image sensor 109, and the rotation of the rotator 104 is converted into the linear movement of the lens assembly 102 through the threaded section.

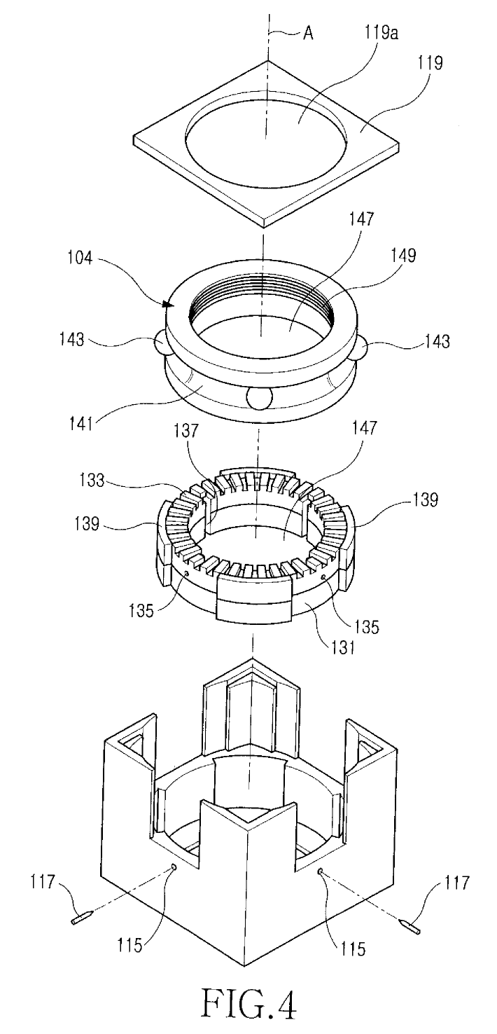

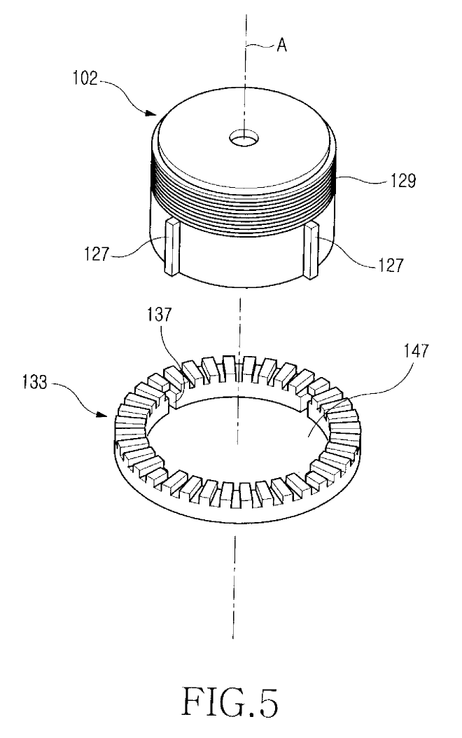

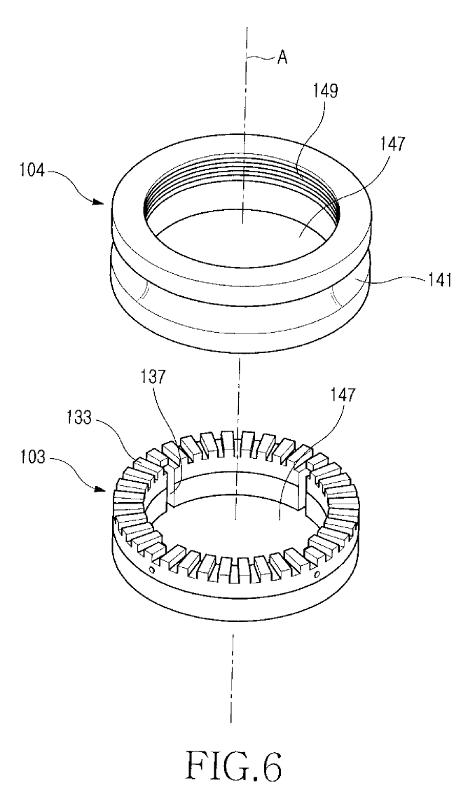

Referring to FIGS. 4 through 6, the piezoelectric motor 103 is assembled to surround the other part of the lens assembly 102 and produces a driving force for rotating the rotator 104. The piezoelectric motor 103 is composed of a piezoelectric element 131 and a stator 133. The respective piezoelectric element 131 and stator 133 are assembled to surround the other part of the lens assembly 102. The stator 133 is placed on the piezoelectric element 131 to be interposed between the piezoelectric element 131 and the rotator 104. When power is applied to the piezoelectric element 131, the piezoelectric element 131 is driven to cause the deformation of the stator 133. As the piezoelectric element 131 is driven, the stator 133 is deformed in a continuous wave pattern in the circumferential direction thereof to produce frictional force between the stator 133 and the rotator 104. The frictional force produced between the stator 133 and the rotator 104 causes the rotator 104 to rotate. In order to facilitate the deformation of the stator 133, a plurality of prominences and depressions are alternately formed and defined on one end surface of the stator 133 in the circumferential direction.

In order to securely maintain the piezoelectric motor 103 within the module housing 101, one or more pinholes 115 (see FIG. 4) are defined to communicate the inside and outside of the module housing 101 with each other, and one or more locking holes 135 are defined on the circumferential outer surface of the piezoelectric motor 103. One or more locking pins 117 respectively pass through the pinholes 115 and are locked into the locking holes 135. Therefore, if the piezoelectric motor 103 produces rotational force, the piezoelectric motor 103 is securely maintained in the module housing 101, and the rotator 104 is rotated in the module housing 101.

Meanwhile, the camera lens module 100 further includes permanent magnets 139 to bring the rotator 104 into close contact with the stator 133, as a result of which frictional force can be reliably produced between the rotator 104 and the stator 133 when the piezoelectric element 131 is driven.

The permanent magnets 139 are mounted to the circumferential outer surface of the piezoelectric motor 103 or the inner surface of the module housing 101 at a position adjacent to the piezoelectric motor 103 and function to apply attractive force to the rotator 104.

By virtue of the attractive force of the permanent magnets 139, the rotator 104 is brought into close contact with the stator 133. Therefore, although the stator 133 is deformed through driving of the piezoelectric element 131, portions of the stator 133 are kept in contact with the rotator 104 and produce frictional force.

A guide section is interposed between the piezoelectric motor 103 and the lens assembly 102 to guide linear movement of the lens assembly 102.

The guide section comprises a through-hole 147 which is defined to extend in the direction of the optical axis ‘A’ of the image sensor 109 and in which the lens assembly 102 is partially received, one or more guide grooves 137 which are defined on the inner surface of the piezoelectric motor 103, and one or more guide projections 127 which are formed on the circumferential outer surface of the lens assembly 102. At this time, the through-hole 147 is defined to pass through the rotator 104 and the piezoelectric motor 103.

As the lens assembly 102 is fitted into the through-hole 147, the piezoelectric motor 103 surrounds the other part of the lens assembly 102, and the lens assembly 102 can be linearly moved through the through-hole 147 in the direction of the optical axis ‘A’ of the image sensor 109.

The guide grooves 137 extend in the direction of the optical axis ‘A’ of the image sensor 109, and the guide projections 127 project from the circumferential outer surface of the lens assembly 102 to be respectively engaged into the guide grooves 137 and linearly moved therein. As the guide projections 127 are engaged and linearly moved in the guide grooves 137, the lens assembly 102 can be linearly moved in the module housing 101 in the direction of the optical axis ‘A’ of the image sensor 109.

If the guide section is not constructed, the lens assembly 102 will be integrally rotated with the rotator 104 in the module housing 101. If the rotation of the rotator 104 is not converted into the linear movement of the lens assembly 102 and the lens assembly 102 is integrally rotated with the rotator 104, it is impossible to adjust a focal distance. Hence, by preventing the rotation of the lens assembly 102 and causing the lens assembly 102 to be linearly moved through using the guide grooves 137 and the guide projections 127, it is possible to adjust the focal distance of the lens assembly 102.

The camera lens module 100 further includes a printed circuit board 191 and a flexible printed circuit board 197 for applying power or a drive signal to the image sensor 109 and the piezoelectric element 131 and transmitting a obtained image signal.

The image sensor 109 is connected to the printed circuit board 191 through a plurality of wires 195 or similar electrical connectors, and the flexible printed circuit board 197 transmits power or a drive signal to the printed circuit board 191. An image signal generated by the image sensor 109 is transmitted through the flexible printed circuit board 197 to an image processing unit (not shown).

The camera lens module 100 further includes an infrared filter 193 which is interposed between the image sensor 109 and the lens assembly 102 to remove a light component which does not belong to a visible ray, that is, an infrared ray, so that a clear image can be obtained.

In the camera lens module 100 constructed as mentioned above, the image sensor 109, the lens assembly 102, the rotator 104 and the piezoelectric motor 103 are received in the module housing 101. When it is necessary to photograph an subject, power is applied to the piezoelectric motor 103 depending upon a distance to the subject to rotate the rotator 104. The rotation of the rotator 104 is converted into the linear movement of the lens assembly 102 by the threaded section, whereby the focal distance of the lenses 121 can be adjusted depending upon a distance to the subject.

As is apparent from the above description, the camera lens module according to the present invention provides advantages in that, since a piezoelectric motor is employed as a driving source for auto-focusing, miniaturization can be advantageously attained. Consequently, the camera lens module having an auto-focusing device can be easily mounted to a digital camera as well as a mobile communication terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A camera lens module comprising:
an image sensor;
a lens assembly arranged on an optical axis of the image sensor;
a rotator rotatably mounted to surround one part of the lens assembly;
a piezoelectric motor mounted to surround another part of the lens assembly, for providing a driving force for rotating the rotator; and
a threaded section formed on the lens assembly and the rotator,
wherein the threaded section converts rotation of the rotator into linear movement of the lens assembly along the optical axis of the image sensor to adjust a focal distance of the lens assembly.

2. The camera lens module as set forth in claim 1, further comprising:
a module housing for receiving the image sensor, the lens assembly, the rotator and the piezoelectric motor; and
permanent magnets mounted in the module housing to bring the rotator into close contact with the piezoelectric motor.

3. The camera lens module as set forth in claim 1, wherein the piezoelectric motor comprises:
a piezoelectric element, and
a stator mounted on the piezoelectric element to be placed between the piezoelectric element and the rotator, wherein, when power is applied to the piezoelectric element, the stator is deformed into a continuous wave pattern in a circumferential direction thereof to produce frictional force between the stator and the rotator and to thereby rotate the rotator.

4. The camera lens module as set forth in claim 3, wherein the piezoelectric element and the stator are assembled to respectively surround the lens assembly.

5. The camera lens module as set forth in claim 3, further comprising:
at least one permanent magnet attached to a circumferential outer surface of the piezoelectric motor,
wherein, an attractive force is applied between the permanent magnet and the rotator causing the rotator is brought into close contact with the stator.

6. The camera lens module as set forth in claim 1, further comprising:
a through-hole defined to pass through the piezoelectric motor and the rotator in a direction of the optical axis of the image sensor;
at least one guide groove defined on an inner surface of the piezoelectric motor to extend in the direction of the optical axis of the image sensor; and
at least one guide projection formed on an outer surface of the lens assembly to extend in the direction of the optical axis of the image sensor,
wherein the guide projection is engaged into the guide groove to guide linear movement of the lens assembly.

7. The camera lens module as set forth in claim 1, further comprising.
a module housing for receiving the image sensor, the lens assembly, the rotator and the piezoelectric motor; and
balls located on a circumferential outer surface of the rotator at regular angles and interposed between an inner surface of the module housing and the circumferential outer surface of the rotator,
wherein the rotator is rotated while being guided by the balls.

8. The camera lens module as set forth in claim 7, further comprising:
a rotation guide groove defined on the circumferential outer surface of the rotator,
wherein the balls are partially received in the rotation guide groove to guide rotation of the rotator.

9. The camera lens module as set forth in claim 1, further comprising:
an infrared filter interposed between the image sensor and the lens assembly.

10. The camera lens module as set forth in claim 1, further comprising:
a module housing for receiving the image sensor, the lens assembly, the rotator and the piezoelectric motor;
at least one pinhole defined to communicate the inside and outside of the module housing with each other;
at least one locking hole defined on a circumferential outer surface of the piezoelectric motor; and
at least one locking pin passing through the pinhole and locked into the locking hole.

11. The camera lens module as set forth in claim 1, further comprising:
a module housing opened on at least one end thereof; and
a cover partially covering the opened end of the module housing and defining an exposure opening,
wherein the image sensor, the lens assembly, the rotator and the piezoelectric motor are received in the module housing, and one end of the lens assembly is exposed through the exposure opening.

12. The camera lens module as set forth in claim 11, wherein the rotator is interposed between the piezoelectric motor and the cover such that linear movement of the rotator is prevented.

13. A camera lens module comprising:
an image sensor;
a lens assembly arranged on an optical axis of the image sensor to be linearly moved;
a rotator rotatably mounted to surround one part of the lens assembly;
a piezoelectric motor mounted to surround the other part of the lens assembly, for providing a driving force for rotating the rotator;
a permanent magnet installed adjacent to the piezoelectric motor to apply attractive force for bringing the rotator into close contact with the piezoelectric motor;
a threaded section formed on the lens assembly and the rotator; and
a guide section provided between the lens assembly and the piezoelectric motor to guide linear movement of the lens assembly,
wherein the threaded section converts rotation of the rotator into linear movement of the lens assembly along the optical axis of the image sensor to adjust a focal distance of the lens assembly.

14. The camera lens module as set forth in claim 13, wherein the threaded section comprises:
a first threaded part formed on a circumferential outer surface of the lens assembly, and
a second threaded part formed on a circumferential inner surface of the rotator and threadedly coupled with the first threaded part.

15. The camera lens module as set forth in claim 13, wherein the guide section comprises:
a through-hole defined to pass through the piezoelectric motor and the rotator in a direction of the optical axis of the image sensor,
at least one guide groove defined on an inner surface of the piezoelectric motor to extend in the direction of the optical axis of the image sensor, and
at least one guide projection formed on an outer surface of the lens assembly to extend in the direction of the optical axis of the image sensor, and wherein the guide projection is engaged into the guide groove to be linearly moved therein.

16. The camera lens module as set forth in claim 13, wherein the piezoelectric motor comprises a piezoelectric element, and a stator mounted on the piezoelectric element to be placed between the piezoelectric element and the rotator; and wherein, when power is applied to the piezoelectric element, the stator is deformed into a wave pattern to produce frictional force between the stator and the rotator and to thereby rotate the rotator.

17. The camera lens module as set forth in claim 13, further comprising:
an infrared filter interposed between the image sensor and the lens assembly.

18. The camera lens module as set forth in claim 13, further comprising:
a module housing opened on at least one end thereof; and
a cover partially covering the opened end of the module housing and defining an exposure opening,
wherein the image sensor, the lens assembly, the rotator and the piezoelectric motor are received in the module housing, and one end of the lens assembly is exposed through the exposure opening.

19. The camera lens module as set forth in claim 13, wherein the permanent magnet is mounted to a circumferential outer surface of the piezoelectric motor.

20. The camera lens module as set forth in claim 13, further comprising:
a module housing for receiving the image sensor, the lens assembly, the rotator and the piezoelectric motor,
wherein the permanent magnet is mounted in the module housing and is positioned adjacent to the piezoelectric motor.
